(19) United States
(12) Patent Application Publication
(10) Pub. No.: US 2009/0144517 A1
(43) Pub. Date: Jun. 4, 2009

(54) DATA PROCESSING APPARATUS AND DATA PROCESSING SYSTEM

(75) Inventors: Ichiki HOMMA, Yokohama (JP); Toru Kengaku, Kobe (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/277,493

(22) Filed: Nov. 25, 2008

(30) Foreign Application Priority Data
Nov. 29, 2007 (JP) 2007-308348

(51) Int. Cl. G06F 12/00

(52) U.S. Cl. 711/167; 711/E12.001

(57) ABSTRACT

Decrease in throughput performance called a “jamming” in a memory device is prevented. There is provided a timing generation part which gives, based on a request signal outputted for each unit of the data processing from a data processing part, an output timing for a burst transfer request to a burst transfer request generation part. Based on the relationship in size between a lapsed time from the output of the burst transfer request to the activation of the request signal and a time specified by a set threshold value of a threshold value register, the timing generation part controls output timing for a burst transfer request. When the lapsed time exceeds the time specified by a maximum threshold value, the burst transfer request generation part is given an output timing for the burst transfer request without waiting for the activation of the request signal. As a result, when the issuance of the request signal is delayed, a next burst transfer request can be given to the memory device without waiting for the issuance but preceding it.

### CLAIM OF PRIORITY

The Present application claims priority from Japanese application JP 2007-308348 filed on Nov. 29, 2007, the content of which is hereby incorporated by reference into this application.

### FIELD OF THE INVENTION

The present invention relates to a control of a memory device by burst transfer. For example, it relates to a technology effectively applicable to a semiconductor device such as an SOC (System-On-Chip) provided with a CODEC which codes and decodes image data per display frame and also effectively applicable to a data processing system.

### BACKGROUND OF THE INVENTION

In order to improve the performance of a data processor or a data processing engine such as a processor and an accelerator installed in the data processing apparatus, an efficient memory access control is important.

For example, when an image is coded or decoded by a data processing engine, it is necessary to transfer (burst transfer) mass data to the data processing engine at one time while maintaining a particular data flow (throughput performance) or more. Generally, in image coding/decoding, the data processing engine divides whole of the process to be performed into certain small units (for example, macro block units), reads required data for each unit processing from a memory device by burst transfer, and repeats an operation required for the image coding/decoding so that required processing is carried out.

As described above, the burst transfer from the memory device must be carried out according to the speed at which the data processing engine completes each unit processing (unit processing pitch). For this reason, the data processing engine issues and sends a signal (unit processing start signal) for controlling the timing with which the burst transfer from the memory device is started to the memory control device. According to the unit processing pitch, which is an interval at which the unit processing start signal is issued, the memory control device conducts burst transfer to the memory device. Thus, efficient memory access has been realized.

FIG. 2 shows an example of a structure of the memory control device for realizing burst transfer according to the unit processing pitch of the data processing engine in the conventional technology. In FIG. 2, in a burst transfer request generation part 10, burst transfer start addresses, the number of bursts, etc. required for burst transfer are set in advance by a main processor etc. for each processing unit. When a unit processing start signal 101 is issued for each given unit processing from a data processing engine 100, in response to this, the burst transfer request generation part 10 outputs a burst transfer request 301 such as a burst accessing command to a memory device 400. Upon receipt of the burst transfer request 301, the memory device 13 outputs data by burst operation. The outputted data is stored in a FIFO buffer 600. Further, the data processing engine 100 performs necessary data processing by use of the data taken out from the FIFO buffer 600.

FIG. 3 shows a flow of the burst transfer processing in the technology of FIG. 2. Just before starting the (i)th unit processing, the data processing engine 100 issues a unit processing start signal 101. When the unit processing start signal 101 is issued, the burst transfer request generation part 10 sends to the memory device 400 a series of burst transfer requests 301 for the purpose of burst transfer necessary for the (i)th unit processing. The memory device 400 outputs required data to the FIFO buffer 600 according to the burst transfer request 301. The data processing engine 100 takes out data from the FIFO buffer 600, and performs the (i)th unit processing.

After completion of the (i)th unit processing, in order to perform the (i+1)th unit processing, the data processing engine 100 repeatedly applies the above series of burst transfer to the data required for the (i+1)th unit processing. Henceforth, the data processing engine 100 continues its processing by repeating the series of operations required times such that the (i+2)th processing is performed after the (i+1)th processing.

Generally, the data processing engine 100 performs the above series of processing with a fixed unit processing pitch depending on the size or complexity of the unit processing. That is, each unit processing is performed such that the issuing interval of the (i)th and the (i+1)th unit processing start signals 101 is substantially the same as that of the (i+1)th and (i+2)th unit processing start signals. Therefore, because the data processing engine 100 issues the unit processing start signals 101 at fixed time intervals, memory access corresponding to each unit processing in the memory device 400 is dispersed at certain fixed time intervals and processed.

However, when completion of a certain unit processing is delayed because of a certain factor such as occurrence of the interrupt to the data processing engine 100, the issuance of the unit processing start signal 101 and the burst transfer request 301 are delayed due to such a delay. Conversely, when certain unit processing is completed earlier due to a certain factor, the unit processing start signal 101 and burst transfer request 301 are issued earlier accordingly. That is, disorder will arise in the memory access to the memory device by “fluctuation” in the completion period of the unit processing.

The above disorder in the memory access may decrease the access efficiency. Patent Document 1 discloses a solution, for example, as a means to prevent the decrease in access efficiency caused by such “fluctuation.” For example, when the memory device 400 performs arbitration processing which accepts the burst transfer request 301 at a fixed time interval (arbitration timing), in a case where the burst transfer request 301 is not given with a certain arbitration timing, the event that the burst transfer request 301 has not been issued with the arbitration timing is stored. Later, when the burst transfer request 301 is issued after the timing and when it is stored that the burst transfer request was not sent with the previous arbitration timing, even if the request is issued before or after the arbitration timing, decrease in access efficiency due to “fluctuation” of the request is prevented by preferentially accepting the request.

FIG. 4 shows a situation which may take place during burst transfer processing in the conventional technology. FIG. 4 shows a situation where the issuance of the unit processing start signal 101 of the (i+1)th unit is delayed because the completion of the (i)th unit processing in the data processing engine 100 is delayed for some reason. The burst transfer request generation part 10 controls so as to issue the burst transfer request 301 to the memory device 400 in synchronism with the issuance of the unit processing start signal 101. Therefore, the burst transfer request 301 is issued with the timing corresponding to the delay of the unit processing start signal 101.

In this regard, according to the method disclosed in Patent Document 1, the memory device 400 preferentially accepts the (i+1)th burst transfer request 301 issued after the normal arbitration timing, and performs the processing earlier or later than the arbitration timing. On the contrary, when the (i)th or the (i+2)th unit processing is completed with a normal unit processing pitch, the burst transfer request 301 corresponding to the (i)th or the (i+2)th unit processing is accepted with a normal arbitration timing in the memory device 400 and is processed.

### [Patent Document 1]

Japanese Unexamined Patent Publication No. 2006-195714

### SUMMARY OF THE INVENTION

However, in a situation shown in FIG. 4, when the (i+1)th and (i+2)th burst transfer requests 301 are issued, being concentrated on the memory device 400, according to the circumstances, the memory device 400 has to carry out the (i+1)th and (i+2)th processing without any margin.

Generally, as for the memory device 400, when burst transfer requests are issued in a concentrated manner, arbitration processing between the requests and memory access processing become complicated inside the memory device 400. Thus, as compared to the case where the burst transfer requests 301 are issued in a dispersed manner, each burst transfer request is processed slower. For example, the response of the data output being burst output from the memory device 401 becomes slow. This symptom is called a “jamming” in the memory device due to the concentration of the burst transfer requests in particular, and becomes one of the factors which decreases throughput performance of the entire system.

It is an objective of the present invention to provide a data processing apparatus and a data processing system which can prevent the decrease in throughput performance being called a “jamming” in the memory device, which is caused when the above burst transfer requests are issued to the memory device in a concentrated manner.

The above mentioned and further objects and novel features of the present invention will become apparent from the description provided in this specification and the attached drawings.

Outlines of aspects and features of the invention disclosed in the present application will be briefly described as follows.

That is, there is provided a timing generation part which gives an output timing for the burst transfer request to the burst transfer request generation part based on a request signal outputted for each processing unit of the data processing from the data processing part. The timing generation part controls the output timing for the burst transfer request based on the relationship in size between a lapsed time from the output of the burst transfer request until the request signal is activated and the time specified by the set threshold value of a threshold value register. For example, when the lapsed time exceeds the time specified by the maximum threshold value, the burst transfer request generation part is given an output timing for the burst transfer request without waiting for the activation of the request signal. When the lapsed time is shorter than the time specified by the minimum threshold value, after a lapse of time specified by the minimum threshold value, the burst transfer request generation part is given an output timing for the burst transfer request.

According to the above, when the issuance of the request signal by the data processing part is delayed, the next burst transfer request can be given to the memory device without waiting for this. Also, when the data processing part has issued a request signal too early, a next burst transfer request can be given to the memory device later than that.

Effects of representative aspects and features of the invention disclosed in the present application will be briefly described as follows. That is, decrease in throughput performance called a “jamming” in the memory device can be prevented.

### BRIEF DESCRIPTION OF THE DRAWINGS

FIG. 1 is a block diagram showing a microcontroller as an example of a data processing apparatus according to the present invention;

FIG. 2 is a block diagram illustrating a configuration of a memory control device of a prior art in which burst transfer in accordance with a unit processing pitch of a data processing engine is achieved;

FIG. 3 is a timing chart showing a flow of burst transfer processing according to the prior art of FIG. 2;

FIG. 4 is a timing chart showing a situation that may occur during the burst transfer processing in the prior art of FIG. 2;

FIG. 5 is a timing chart showing a flow of a burst transfer operation for each unit processing in the microcontroller of FIG. 1;

FIG. 6 is a block diagram illustrating another microcontroller as a data processing apparatus according to the present invention;

FIG. 7 illustrates a flow of memory transfer for each unit processing in the microcontroller of FIG. 6; and

FIG. 8 is a timing chart illustrating another case regarding a flow of the memory transfer for each unit processing in the microcontroller of FIG. 6.

### DETAILED DESCRIPTION OF THE PREFERRED EMBODIMENTS

### 1. Outlines of Embodiments

First, outlines of typical embodiments of the invention disclosed in the present application will be briefly described. The components denoted with the reference characters in parentheses in the outlines of the typical embodiments are indicated as exemplarily only and the present invention is not limited thereby.

[1] The data processing apparatus (50) comprises: a data processing engine (100) which performs data processing by using data sequentially read from a memory device; a burst transfer request generation part (200) which outputs a burst transfer request (301) to the memory device in order to read data sequentially; and a timing generation part (503) which gives an output timing for the burst transfer request to the burst transfer request generation part based on a request signal (101) outputted for each processing unit of the data processing from the data processing engine. When a lapsed time from the output of the burst transfer request (301) to the activation of the request signal (101) exceeds the time specified by the set value of a threshold value register (500), the timing generation part gives the output timing for the burst transfer request to the burst transfer request generation part without waiting for the activation of the request signal.

As a result of the above, when the issuance of the request signal by the data processing part is delayed, the memory device can be given a next burst transfer request without waiting for the delayed request signal.

[2] The data processing apparatus of the item 1 further comprises a control part (700) which can read from and write to the threshold value register. Thus, the threshold value register can be set in a programmable manner.

[3] The data processing apparatus (50A) comprises: a data processing engine which performs data processing by using data sequentially read from a memory device; a burst transfer request generation part which outputs a burst transfer request to the memory device in order to read data sequentially; and a timing generation part which gives an output timing for the burst transfer request to the burst transfer request generation part based on a request signal outputted for each processing unit of the data processing from the data processing engine. When a lapsed time from the output of the burst transfer request to the activation of the request signal is shorter than the time specified by the set value of a first threshold value register (500B), after the lapsed time specified by the set value of the first threshold value register, the timing generation part gives an output timing for the burst transfer request to the burst transfer request generation part.

As a result of the above, when the data processing part has issued a request signal too early, a next burst transfer request can be given to the memory device later than that.

[4] In the data processing apparatus of the item 3, when the lapsed time from the output of the burst transfer request to the activation of the request signal exceeds the time specified by the set value of a second threshold value register (500A), the timing generation part further gives an output timing for a burst transfer request to the burst transfer request generation part without waiting for the activation of the request signal.

As a result, when the issuance of the request signal by the data processing part is delayed, a next burst transfer request can be given to the memory device without waiting for the issuance but preceding it.

[5] The data processing apparatus of the item 4 further comprises a control part which can read from and write to the first and second threshold value registers. Accordingly, it becomes possible to set the first and second threshold value registers in a programmable manner.

[6] In the data processing apparatus of the item 5, the data processing engine is a CODEC which codes and decodes image data and is formed on a single semiconductor substrate, which can contribute to acceleration of the CODEC processing.

[7] The data processing system comprises: a memory device; a first data processing apparatus capable of accessing the memory device; and a second data processing apparatus capable of accessing the memory device. The first data processing apparatus comprises: a data processing engine which performs data processing by using data sequentially read from the memory device; a burst transfer request generation part which outputs a burst transfer request to the memory device in order to read data sequentially; and a timing generation part which gives an output timing for the burst transfer request to the burst transfer request generation part based on a request signal outputted for each processing unit of the data processing from the data processing part. When a lapsed time from the output of the burst transfer request to the activation of the request signal exceeds the time specified by the set value of a threshold value register, the timing generation part gives the output timing for the burst transfer request to the burst transfer request generation part without waiting for the activation of the request signal.

As a result of the above, when the issuance of the request signal from the data processing part is delayed, a next burst transfer request can be given to the memory device without waiting for the issuance but preceding it. Therefore, even when “fluctuation” occurs in the data processing by the first data processing apparatus, burst transfer requests can be prevented from concentrating on the memory device. Further, even when an access to the memory device by the second data processing apparatus takes place in the meantime, a “jamming” in the memory device due to concentration of the access requests can be eased, contributing to improvement in throughput performance of the whole data processing system.

[8] The data processing system comprises: a memory device; a first data processing apparatus capable of accessing the memory device; and a second data processing apparatus capable of accessing the memory device. The first data processing apparatus comprises: a data processing engine which performs data processing by using data sequentially read from the memory device; a burst transfer request generation part which outputs a burst transfer request to the memory device in order to read data sequentially; and a timing generation part which gives an output timing for the burst transfer request to the burst transfer request generation part based on a request signal outputted for each processing unit of the data processing from the data processing part. When a lapsed time from the output of the burst transfer request to the activation of the request signal is shorter than the time specified by the set value of a first threshold value register, the timing generation part gives an output timing for the burst transfer request to the burst transfer request generation part after the lapsed time specified by the set value of the second threshold value register.

As a result of the above, when the issuance of a request signal by the data processing engine is too early, a next burst transfer request can be given to the memory device later than that. Therefore, even when “fluctuation” occurs in the data processing by the first data processing apparatus, burst transfer requests can be prevented from concentrating on the memory device. Further, even when an access to the memory device by the second data processing apparatus takes place in the meantime, a “jamming” in the memory device due to concentration of the access requests can be eased, contributing to improvement in throughput performance of the whole data processing system.

[9] In the data processing system of the item 8, when the lapsed time from the output of the burst transfer request to the activation of the request signal exceeds the time specified by the set value of a second threshold value register, the timing generation part further gives an output timing for a burst transfer request to the burst transfer request generation part without waiting for the activation of the request signal.

As a result, when the issuance of the request signal from the data processing engine is delayed, a next burst transfer request can be given to the memory device without waiting for the issuance but preceding it.

[10] In the data processing system of the item 9, when a lapsed time from the output of the burst transfer request to the activation of the request signal exceeds the time defined by the set value of the first threshold value register and is shorter than the time specified by the set value of the second threshold value register, in synchronism with the activation of the request signal, the timing generation part gives an output timing for a burst transfer request to the burst transfer request generation part.

### 2. Details of Embodiments

The embodiments will further be described in detail. Below, the present invention will be described by way of embodiments with reference to the accompanying drawings. Incidentally, throughout the drawings for describing the embodiments, the elements having the same function are represented by the same reference numerals and characters, and the repeated description thereon is omitted.

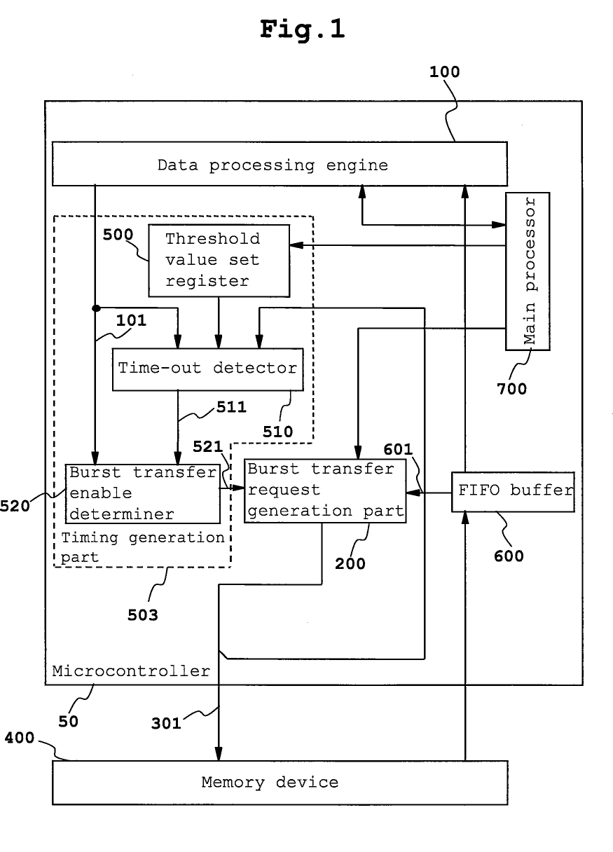

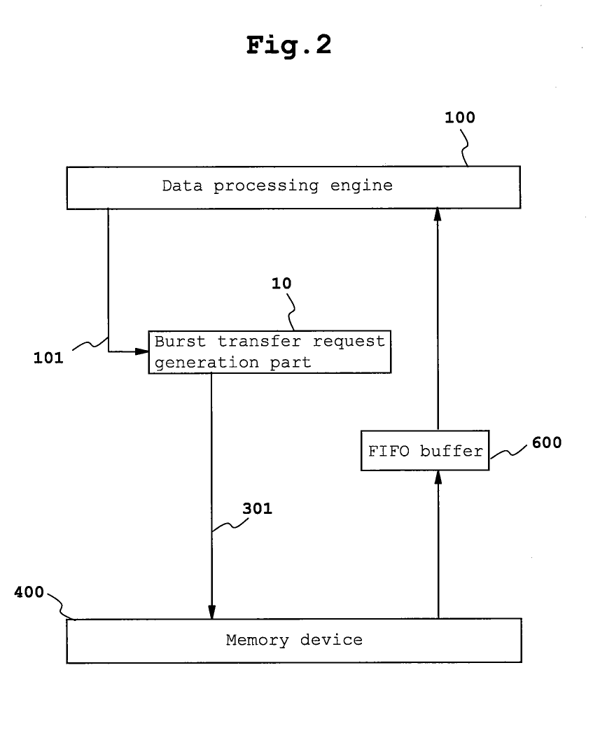

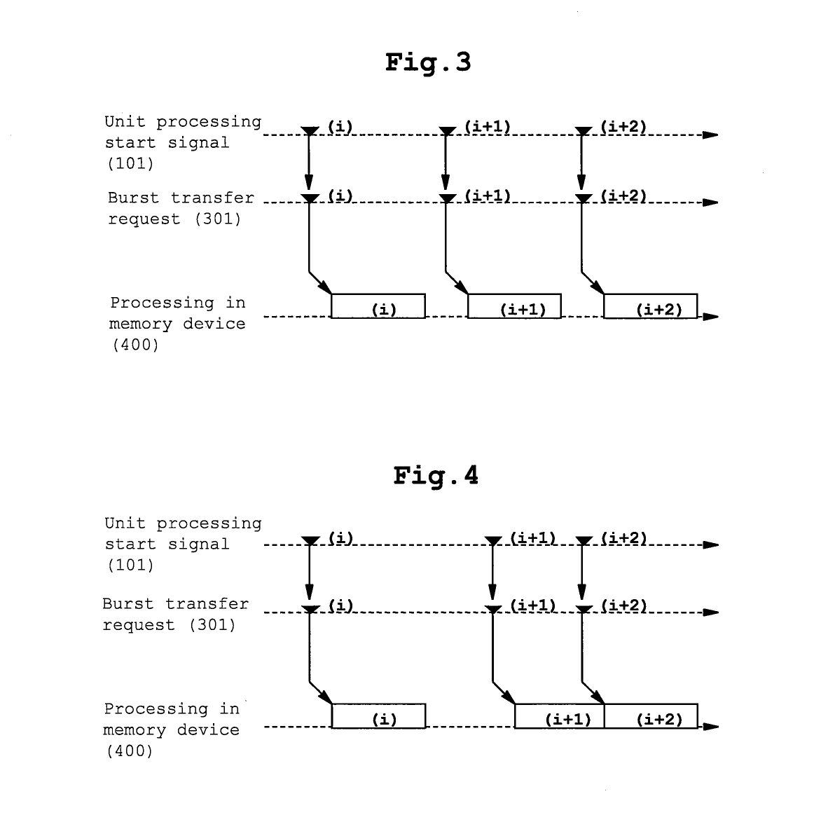

A microcontroller 50 is shown in FIG. 1 as an example of the data processing apparatus according to the present invention. Although not particularly restricted, the microcontroller 50 is formed on one semiconductor substrate such as of single crystal silicon by a CMOS integrated-circuit manufacturing technology etc. and is configured, for example, as an SOC.

A memory device 400 shown typically is coupled to the microcontroller 50. Although not shown, the memory device 400 is shared also with other data processing apparatuses through a bus. In regard to the memory device 400, by being given, for example, a burst access command etc. like a synchronous DRAM, a burst transfer operation for continuously outputting data specified by the command is available. Further, the memory device 400 is not limited to a synchronous DRAM, and it may be a synchronous SRAM etc.

The microcontroller 50 comprises: a main processor 700 which is in charge of the overall control; and a data processing engine 100 which performs data processing using the data read sequentially from the memory device 400. The data processing engine 100 is regarded as an accelerator for the main processor 700. Although not particularly restricted, according to an instruction from the main processor 700, the data processing engine 100 performs coding/decoding etc. of image data. For example, it reads the image data of a coded display frame for each unit processing such as a decoding unit from the memory device 400 sequentially and repeats the data processing. Hereafter, a configuration for the microcontroller to access the memory device 400 will be described in detail.

In order to gain burst access to the memory device 400, the microcontroller 50 comprises: a burst transfer request generation part 200; and a timing generation part 503. A FIFO (First In First Out) buffer 600 is provided on a read data path arranged from the memory device 400 to the data processing engine 100, and the FIFO buffer 600 outputs data 601 about a current usable space to the burst transfer request generation part 200. Assuming that burst transfer conditions such as a transfer start address of the burst transfer and the numbers of transfer words are initialized and there is a usable space required for the FIFO buffer 600, in response to a transfer instruction from the timing generation part 503 by way of a burst transfer enable signal 521, the burst transfer request generation part 200 is allowed to output burst transfer requests 301 such as a burst access command to the memory device 400.

The data processing engine 100 outputs a unit processing start signal 101 for each unit processing of data processing. The timing generation part 503 generates the timing signal 521 based on the unit processing start signal 101 etc. The timing generation part 503 comprises: a threshold value set register 500; a time-out detector 510; and a burst transfer enable determiner 520. The main processor 700 makes the threshold value set register 500 to be capable of read and write access, and an upper limit for a required lapsed time is set. The time-out detector 510 measures a lapsed time after the burst transfer request 301 is issued. Then, the time-out detector 510 compares the measured time with the time specified by the threshold value set register 500. Subsequently, the time-out detector 510 determines whether or not the lapsed time has exceeded the specified time, namely, a time-out has occurred with respect to the unit processing start signal 101. When the time-out has occurred, a time-out signal 511 is activated, namely, it is allowed to be at an enable level. When the unit processing start signal 101 is activated before the occurrence of the time-out, the measuring operation is terminated, and preparation is made for a next measuring operation. The burst transfer enable determiner 520 inputs the unit processing start signal 101 and the time-out signal 511. Further, when the time-out signal 511 is activated before the activation of the unit processing start signal 101, in synchronism with it, the burst transfer enable signal 521 is activated. When the unit processing start signal 101 is activated before the activation of the time-out signal 511, in synchronism with it, the burst transfer enable signal 521 is activated.

Upon receipt of the transfer request 301, the memory device 400 performs a burst read operation according to the instruction and gives read data 401 to the FIFO buffer 600. Though not shown, in case the memory device 400 is also accessible from another processor, following arbitration means may be adopted at the time of the memory device 400 accepting the burst transfer request 301. That is, the one which regularly performs arbitration at fixed time intervals, the one which performs arbitration every time the burst transfer request 301 is issued at a certain timing, or the like may be adopted.

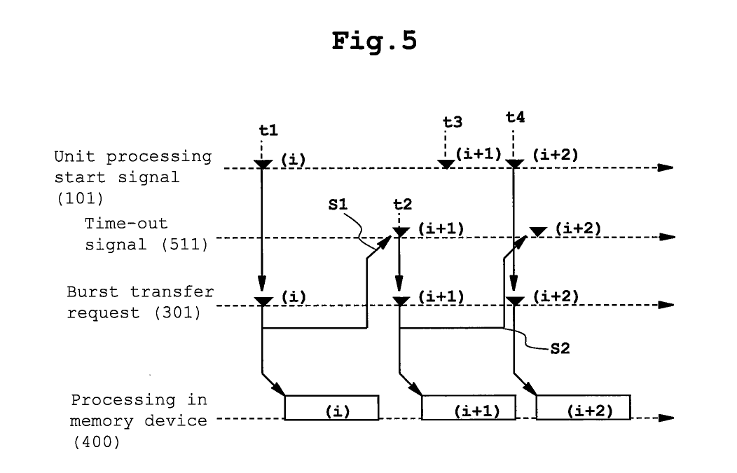

FIG. 5 illustrates a flow of the burst transfer operation for each unit processing in the microcontroller 50 of FIG. 1. In this regard, it is assumed that, through the main processor 700, there is set in the threshold value set register 500 a threshold value showing an upper limit value of a certain proper lapsed time.

Immediately before starting the (i)th unit processing, the data processing engine 100 issues a unit processing start signal 101 (t1) corresponding to the (i)th unit processing. On receiving activation of the burst transfer enable signal 521, the burst transfer request generation part 200 sends a burst transfer request 301 to the memory device 400 when the FIFO buffer has a necessary usable space. According to the burst transfer request 301, the memory device 400 performs necessary internal processing, and then outputs the corresponding data 401 to the FIFO buffer 600.

In parallel with the above operation, the timing generation part 503 monitors the burst transfer of the data necessary for the (i+1)th unit processing. That is, when the burst transfer request 301 corresponding to the (i)th unit processing is issued, the time-out detector 510 resets a counter for measuring the lapsed time to “0”, and monitors a lapsed time after the (i)th burst transfer request 301 has been issued (S1). The counter may be incremented by +1 for each given time interval. For example, the time-out detector 510 may be provided with a timer counter. While comparing the value measured by the counter therein with the set value of the threshold value set register 500, the time-out detector 510 monitors the issuance of the (i+1)th unit processing start signal 101. Further, the time-out detector 510 determines, before the issuance of the (i+1)th unit processing start signal 101, whether or not the lapsed time after the issuance of the (i)th burst transfer request 301 exceeds the set value of the threshold value set register 500, namely, whether or not the time-out has occurred.

In this regard, FIG. 5 shows a case where the time-out has occurred (t2) before the issuance of the (i+1)th unit processing start signals 101. In this case, when the time out signal 511 corresponding to the (i+1)th unit processing has been issued before the unit processing start signal 101 corresponding to the (i+1)th unit processing, the burst transfer enable determiner 520 issues a burst transfer enable signal 521 to the burst transfer request generator 200 in order to perform burst transfer corresponding to the (i+1)th unit processing without waiting for the issuance of the unit processing start signal 101. In this regard, even if the (i+1)th unit processing start signal 101 is issued at t3 after the burst transfer enable signal 521 has been issued, the burst transfer enable determiner 520 determines that the burst transfer enable signal 521 corresponding to the (i+1)th unit processing has already been issued and does not issue an extra burst transfer enable signal 521.

When the (i+1)th burst transfer enable signal 521 is issued at time t2, the burst transfer request generation part 200 makes sure that the FIFO buffer 600 has a necessary usable space and issues a burst transfer request 301 to the memory device 400. Upon receipt of the burst transfer request 301, the memory device 400 outputs corresponding data to the FIFO buffer 600.

As described above, in parallel with the above operation, when the burst transfer request 301 corresponding to the (i+1)th unit processing has been issued at time t2, the time out detector 510 resets the counter for measuring the lapsed time to “0,” and monitors the time lapsed after the (i+1)th burst transfer request 301 has been issued at time t2. While comparing a value of the counter therein with the set value of the threshold value set register 500, the time-out detector 510 monitors the issuance of an (i+2)th unit processing start signal 101 from the data processing engine 100. Further, the time out detector 510 determines whether or not the lapsed time has exceeded the threshold value (time-out) before the issuance of the (i+2)th unit processing start signal 101 (S2). FIG. 5 shows a case where the (i+2)th unit processing start signals 101 is issued (time t4) before the time-out occurs. In this case, when the unit processing start signal 101 corresponding to the (i+2)th unit processing has been issued before the time out signal 511 corresponding to the (i+2)th unit processing, in order to perform the burst transfer corresponding to the (i+2)th unit processing, the burst transfer enable determiner section 520 issues a burst transfer enable signal 521 to the burst transfer request generation part 200. Thereby, the burst transfer request generation part 200 issues a burst transfer request 301 corresponding to the (i+2)th unit processing to the memory device 400, resets the counter therein to “0”, and suppresses additional output of the time-out signal 511.

As described above, even though each interval of the (i)th, (i+1)th, and (i+2)th unit processing start signals 101, namely, the pitch of the unit processing by the data processing engine fluctuates back and forth, the timings at which the burst transfer requests 301 corresponding to the (i)th, (i+1)th, and (i+2)th unit processing are issued are dispersed at time intervals near the threshold value specified by the threshold value set register 500. Since the burst transfer requests 301 are issued in a properly dispersed manner, the memory device 400 is capable of outputting corresponding data in a constantly optimum state. Therefore, it is expected that the optimum throughput can be secured as a whole system.

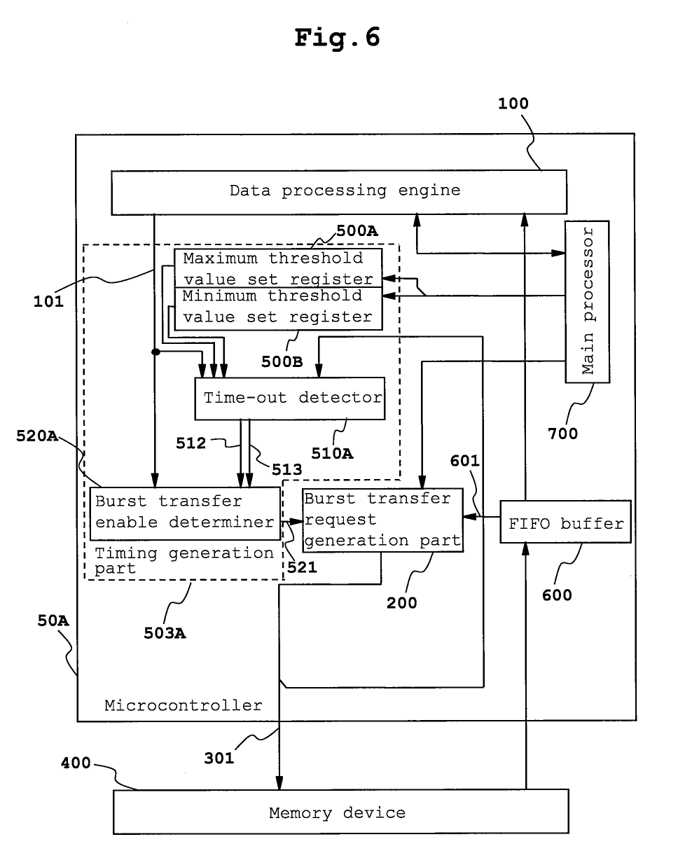

FIG. 6 illustrates another microcontroller 50A as a data processing apparatus according to the present invention. The microcontroller 50A differs from the microcontroller 50 shown in FIG. 1 in that the time-out detection signal is generated by using set values of a maximum threshold value set register 500A and a minimum threshold value set register 500B. The difference will be explained below, and details of the rest of the points will be omitted.

In the maximum threshold value set register 500A, an upper limit value of a lapsed time is set by the main processor 700. Also, in the minimum threshold value set register 500B, a lower limit value of a certain lapsed time is set by the main processor 700. The main processor 700 specifies given maximum and minimum lapsed times in both the registers 500A and 500B. The time-out detector 510A measures a lapsed time after the issuance of a memory transfer request 310 and compares it with the maximum and minimum threshold values specified in the registers 500A and 500B. Thus, the time out detector 510A determines whether or not the time-out has occurred with respect to the unit processing start signal 101. Numeral 512 represents a time-out signal corresponding to an upper limit time (maximum time-out signal) and numeral 513 represents a time-out signal corresponding to a lower limit time (minimum time-out signal). When detecting the activation of the unit processing start signal 101 before the time-out by the time-out signal 513, the burst transfer enable determiner 520A waits for a time-out by the time-out signal 513 and gives a burst transfer enable signal 521 to a burst transfer request generation part 200. When not having detected the activation of the unit processing start signal 101 before the time-out by the time-out signal 512, in synchronism with the time-out by the time-out signal 512, the burst transfer enable determiner 520A gives a burst transfer enable signal 521 to the burst transfer request generation part 200. After the time-out by the time-out signal 513 and when not having detected the activation of the unit processing start signal 101 before the time-out by the time-out signal 512, in synchronism with the activation of the unit processing start signal 101, the burst transfer enable determiner 520A gives the burst transfer enable signal 521 to the burst transfer request generation part 200. The function of the burst transfer request generation part 200 to which the burst transfer enable signal 521 is given is the same as that of the case in FIG. 1.

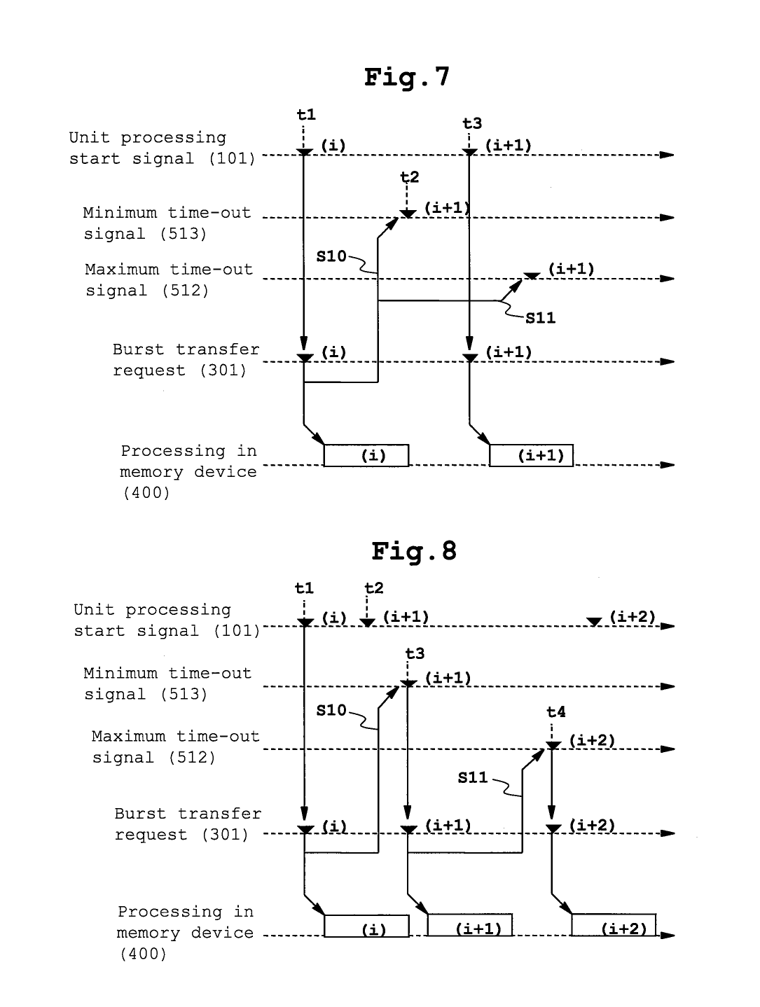

The flow of the memory transfer for each unit processing in the microcontroller 50A of FIG. 6 is illustrated in FIG. 7. In this regard, it is assumed that, in the threshold value set registers 500A and 500B, maximum and minimum threshold values showing upper and lower limit values of a certain proper lapsed time are set.

Immediately before the data processing engine 100 starts the (i)th unit processing, the unit processing start signal 101 corresponding to the (i)th unit processing is issued (t1). As will be described later, when the unit processing start signal 101 is issued after the minimum time-out signal 513 and before the maximum time-out signal 512, the burst transfer enable determiner 520A immediately issues a burst transfer enable signal 521. When the burst transfer enable signal 521 is established, if the FIFO buffer 600 has an enough usable space, the burst transfer request generation part 200 sends a burst transfer request 301 to the memory device 400. After performing necessary internal processing accordingly, the memory device 400 outputs corresponding data.

In parallel with the above operation, the time-out detector 510A monitors the burst transfer of data which the unit processing start signal 100 needs for the (i+1)th unit processing. To be specific, when the burst transfer request 301 corresponding to the (i)th unit processing is issued, the time-out detector 510A resets its counter for measuring lapsed time to “0,” and monitors the lapsed time from the issuance of the (i)th burst transfer request 301. The counter may be configured such that it is incremented by +1 at a certain time interval.

While comparing the value measured by the counter therein with the values of the threshold value set registers 500A and 500B, the time-out detector 510A monitors the issuance of an (i+1) th unit processing start signal 101 by the data processing engine 100. Further, the time-out detector 510A determines whether or not the time at which the (i+1)th unit processing start signal 101 is issued is earlier than the minimum threshold value (early pitch) with respect to the lapsed time from the issuance of the (i)th burst transfer request 301, whether or not the time is later than the minimum threshold value and earlier than the maximum threshold value (on-time pitch), or whether or not it exceeds the maximum threshold value (time-out) (S10).

In this regard, FIG. 7 shows a case where the (i+1)th unit processing start signal 101 is issued at on-time pitch. That is, a minimum time-out signal 513 is outputted at time t2. In this case, in synchronism with time t3 at which the (i+1)th unit processing start signal 101 is issued, the burst transfer enable determiner 520A performs burst transfer corresponding to the (i+1)th unit processing. Therefore, it issues a burst transfer enable signal 521. In this regard, accompanying the issuance of the burst transfer enable signal 521, the burst transfer request 301 corresponding to the (i+1)th unit processing is issued immediately. As a result, the counter inside the time-out detector 510A is reset to “0” before it detects a time-out. Thus, an extra burst transfer enable signal 521 due to the time-out is not issued.

When the (i+1)th burst transfer enable signal 521 is issued, the burst transfer request generator 200 issues a burst transfer request 301 corresponding to the (i+1)th unit processing to the memory device 400.

In parallel with the above operation, as described earlier, the time-out detector 510A monitors the burst transfer of data which the data processing engine 100 needs for the (i+2)th unit processing. To be specific, when the burst transfer request 301 corresponding to the (i+1)th unit processing is issued, the time out detector 510A resets its counter to “0,” and monitors the lapsed time from the issuance of the (i+1)th burst transfer request 301 (S11).

FIG. 8 illustrates another case of the flow of the memory transfer for each unit processing in the microcontroller 50A of FIG. 6. In this regard, it is assumed that, in the threshold value set registers 500A and 500B, there are set maximum and minimum threshold values showing upper and lower limit values of a certain proper lapsed time. Also, the operation and monitoring with regard to the issuance of the (i)th unit processing start signal 101 in FIG. 8 is exactly the same as that of FIG. 7.

While comparing the value measured by its counter with the set values of the threshold value set registers 500A and 500B, the time-out detector 510A monitors the issuance of the (i+1)th unit processing start signal 101 from the data processing engine 100. Further, the time-out detector 510A determines whether or not the time at which the (i+1)th unit processing start signal 101 is issued is earlier (early pitch) than the minimum threshold value with respect to the lapsed time from the issuance of the (i)th burst transfer request 301, whether or not the time is later than the threshold value and earlier than the maximum threshold value (on-time pitch), or whether or not the time exceeds the maximum threshold value (time out) (S10).

FIG. 8 shows a case where the (i+1)th unit processing start signal 101 is issued at an early pitch. In this regard, the burst transfer enable determiner 520A determines that the unit processing pitch of the unit processing start signal 101 is earlier than the specified pitch. As a result, the burst transfer enable determiner 520A does not issue the burst transfer enable signal 521 at the issuing timing (t2) of the (i+1)th unit processing start signal 101. Further, the burst transfer enable determiner 520A waits for the issuance of the minimum time-out signal 513 and issues the burst transfer enable signal 521 to the burst transfer request generation part 200 (t3). In this regard, the burst transfer request 301 corresponding to the (i+1)th unit processing is issued accompanying the issuance of the burst transfer enable signal 521. As a result, the counter inside the time-out detector 510A is reset to “0” before it detects a time-out. Therefore, an extra burst transfer request 521 due to the time-out is not issued.

When the (i+1)th transfer enable signal 521 is issued, the burst transfer request generation part 200 issues the burst transfer request 301 corresponding to the (i+1)th unit processing to the memory device 400. The memory device 400 accepts a request issued through the burst transfer request 301 and outputs corresponding data.

In parallel with the above operation, as described earlier, the time-out detector 510A monitors the burst transfer of data required for the (i+2)th unit processing (S11). To be specific, when the burst transfer request 301 corresponding to the (i+1)th unit processing is issued, the time-out detector 510A resets the counter therein for measuring the lapsed time to “0” and monitors the lapsed time from the issuance of the (i+1)th burst transfer request 301. That is, while comparing the value measured by its counter with the low maximum/minimum threshold values set in the threshold value set registers 500A and 500B, the time-out detector 510A monitors the issuance of the (i+2)th unit processing start signal 101 from the data processing engine 100. Further, the time out detector 510A determines whether or not the time at which the (i+2)th unit processing start signal 101 is issued is earlier (early pitch) with respect to the lapsed time from the issuance of the (i+1)th burst transfer request 301 than the minimum threshold value, whether or not the time is later than the minimum threshold value and earlier than the maximum threshold value (on-time pitch), or whether or not the time exceeds the maximum threshold value (time-out) (S11).

In this regard, FIG. 8 shows a case where the time-out occurs before the issuance of the (i+2)th unit processing start signal 101. In this regard, when the maximum time-out signal 512 corresponding to the (i+2)th unit processing is issued before the unit processing start signal 101 corresponding to the (i+2)the unit processing (t4), the burst transfer enable determiner 520A performs burst transfer corresponding to the (i+2)th unit processing without waiting for the issuance of the unit processing start signal 101. Therefore, it issues a burst transfer enable signal 521 to the burst transfer request generation part 200. In this regard, even if the (i+2)th unit processing start signal 101 is issued after the issuance of the burst transfer enable signal 521, the burst transfer enable determiner 520A determines that the signal 521 corresponding to the (i+2)th unit processing has already been issued, and does not issue an extra burst transfer enable signal 521.

As described above, although unit processing pitches of the data processing engine 100, which are intervals of the (i)th, (i+1)th, and (i+2)th unit processing start signals 101, fluctuate back and forth, the timings at which the burst transfer requests 301 corresponding to the (i)th, (i+1)th, and (i+2)th unit processing are issued are dispersed from one another in such a manner that each processing unit stays within the time limited by the maximum/minimum threshold values specified by the threshold value set registers 500A and 500B. With respect to the memory device 40, since the burst transfer requests 301 are issued in a properly dispersed manner, it becomes possible to access corresponding data in a constantly optimum state. Thus, it can be expected that an optimum throughput is secured as a whole system.

According to the examples of FIGS. 1 and 6 described above, even when the unit processing pitch of the data processing engine becomes earlier or later due to a certain factor, based on a specified threshold value, it becomes possible to properly disperse and issue the memory transfer requests to the memory device. As a result, the memory device becomes capable of accessing corresponding data in a constantly optimum state. Thus, it can be expected that an optimum throughput is secured as a whole system.

Although the present invention made by the inventors has been specifically explained in conjunction with the above mentioned embodiments, it is needless to say that the present invention is not limited to the above mentioned embodiments and various modifications can be made without departing from the gist of the present invention.

For instance, in the above example, by use of the main processor, a user can set the threshold value set registers 500, 500A, and 500B at will. However, it may be such that the timing generation part can update the threshold value to be set. In that case, for example, when the (i+1)th unit processing start signal is issued, the timing generation part can perform processing while autonomously setting the optimum threshold value by updating the threshold value in the threshold value set register by use of a mean value of the (1)th to (i)th unit processing pitches.

Also, the FIFO buffer 600 is a memory for absorbing the difference between the data-output rate of the memory device and the working speed of the data processing engine. Therefore, if the operational speeds of the two are the same, the FIFO buffer need not be provided.

In the above explanation, the operation of the data processing engine (for image processing, for instance) is taken as an example. However, it is not limited to the data processing engine. For example, it can be applied to a system in which the data processing engine is replaced with a processor. Also, it is not always necessary to be coupled with the memory device on a one-for-one basis. It is conceivable that it can be applied to the ones where two or more pairs of the data processing engines and memory control devices in the embodiments are coupled to the memory device (through a bus, for instance).

What is claimed is:

1. A data processing apparatus comprising:
a data processing part which performs data processing by using data sequentially read from a memory device;
a burst transfer request generation part which outputs a burst transfer request to the memory device in order to read data sequentially; and
a timing generation part which gives an output timing for the burst transfer request to said burst transfer request generation part based on a request signal outputted for each unit of the data processing from the data processing part,
wherein, when a lapsed time from the output of said burst transfer request to the activation of said request signal exceeds the time specified by the set value of a threshold value register, said timing generation part gives the output timing for the burst transfer request to said burst transfer request generation part without waiting for the activation of the request signal.

2. A data processing apparatus according to claim 1, comprising a control part which can read from and write to said threshold value register.

3. A data processing apparatus comprising:
a data processing part which performs data processing by using data sequentially read from a memory device;
a burst transfer request generation part which outputs a burst transfer request to the memory device in order to read data sequentially; and
a timing generation part which gives an output timing for the burst transfer request to said burst transfer request generation part based on a request signal outputted for each unit of the data processing from the data processing part,
wherein, when a lapsed time from the output of said burst transfer request to the activation of said request signal is shorter than the time specified by the set value of a first threshold value register, after the lapsed time specified by the set value of said first threshold value register, said timing generation part gives an output timing for the burst transfer request to said burst transfer request generation part.

4. A data processing apparatus according to claim 3, wherein, when the lapsed time from the output of said burst transfer request to the activation of said request signal exceeds the time specified by the set value of a second threshold value register, said timing generation part gives an output timing for a burst transfer request to said burst transfer request generation part without waiting for the activation of said request signal.

5. A data processing apparatus according to claim 4, comprising a control part which can read from and write to said first and second threshold value registers.

6. A data processing apparatus according to claim 5, wherein said data processing part is a CODEC which codes and decodes image data and is formed over a single semiconductor substrate.

7. A data processing system comprising:
a memory device;
a first data processing apparatus capable of accessing said memory device; and
a second data processing apparatus capable of accessing said memory device,
wherein said first data processing apparatus comprises: a data processing part which performs data processing by using data sequentially read from said memory device; a burst transfer request generation part which outputs a burst transfer request to the memory device in order to read data sequentially; and a timing generation part which gives an output timing for the burst transfer request to said burst transfer request generation part based on a request signal outputted for each processing unit of the data processing from said data processing part; and
wherein, when a lapsed time from the output of said burst transfer request to the activation of said request signal exceeds the time specified by the set value of a threshold value register, said timing generation part gives the output timing for the burst transfer request to said burst transfer request generation part without waiting for the activation of said request signal.

8. A data processing system comprising: a memory device; a first data processing apparatus capable of accessing said memory device; and a second data processing apparatus capable of accessing said memory device,
wherein said first data processing apparatus comprises: a data processing part which performs data processing by using data sequentially read from said memory device; a burst transfer request generation part which outputs a burst transfer request to the memory device in order to read data sequentially; and a timing generation part which gives an output timing for the burst transfer request to said burst transfer request generation part based on a request signal outputted for each processing unit of the data processing from said data processing part; and
wherein, when a lapsed time from the output of said burst transfer request to the activation of said request signal is shorter than the time specified by the set value of a first threshold value register, said timing generation part gives an output timing for the burst transfer request to said burst transfer request generation part after the lapsed time specified by the set value of said first threshold value register.

9. A data processing system according to claim 8, wherein, when the lapsed time from the output of said burst transfer request to the activation of said request signal exceeds the time specified by the set value of a second threshold value register, said timing generation part gives an output timing for a burst transfer request to said burst transfer request generation part without waiting for the activation of said request signal.

10. A data processing system according to claim 9, wherein, when the lapsed time from the output of said burst transfer request to the activation of said request signal exceeds the time specified by the set value of the first threshold value register and is shorter than the time specified by the set value of the second threshold value register, said timing generation part gives an output timing for a burst transfer request to said burst transfer request generation part in synchronism with the activation of said request signal.
